(19) United States
(12) Patent Application Publication
(10) Pub. No.: US 2005/0053289 A1
(43) Pub. Date: Mar. 10, 2005

(54) Staged full-image decompressing, re-sizing and half-toning by less than full-image data-file stages

(75) Inventor: John J. Burlingame, Camas, WA (US)

Correspondence Address: Robert D. Varitz;ROBERT D.VARITZ, P.C., 2007 S.E. Grant Street, Portland, OR, 97214, US

(73) Assignee: Sharp Laboratories of America, Inc.

(21) Appl. No.: 10/726,798

(22) Filed: Dec. 2, 2003

Related U.S. Application Data
(60) Provisional application No. 60/500,402, filed on Sep. 5, 2003.

(51) Int. Cl. G06K 9/36

(52) U.S. Cl. 382/233

(57) ABSTRACT

Offered by the present invention is an image decompression and half-toning system and methodology which operate in stages to select portions, but not the entirety, of the relevant image data file that is to be processed. With respect to each handled portion, practice of the invention involves performing first an appropriate decompression function, next, a half-toning function, and then, a buffer-storing function.

### CROSS REFERENCE TO RELATED APPLICATION

This application claims priority to U.S. Provisional Patent Application Ser. No. 60/500,402 covering an invention entitled “Staged Full-Image Decompressing and Half-Toning By Less than Full-Image Data-File Stages”, filed Sep. 5, 2003. The inventorship is the same in that provisional application as it is in this application, and the entirety of that provisional patent application is hereby incorporated herein by reference.

### BACKGROUND AND SUMMARY OF THE INVENTION

The present invention relates to a unique system and methodology for decompressing and half-toning an image data file utilizing an approach in which decompressing and half-toning activities take place in stages, each of which involves image processing in “units” defined generally by being less than the whole of the relevant, full-image data file.

According to practice of this invention, an image data file, such as a compressed image data file, is treated in stages which involve less than the full content of the file, such as on a line-by-line basis, or a several-line by several-line basis. In each of these stages, the invention (a) first performs, with respect to yet un-decompressed image data, a decompression function, (b) next performs any image-line (or row) resizing which may be necessary, (c) next performs a half-toning function regarding what has just been decompressed, and (d) then performs a buffer-storage function relative to the completed, just decompressed and half-toned partial result, until all of the subject data in an image file has been handled.

The various features and advantages of the invention will become more fully apparent as the description which now follows is read in conjunction with the accompanying drawings.

### DESCRIPTION OF THE DRAWINGS

FIG. 1 is a simplified block/schematic diagram illustrating the structure and methodology of the present invention.

FIG. 2 is a more detailed block/schematic diagram further illustrating the structure and methodology of what is shown in FIG. 1.

### DETAILED DESCRIPTION OF THE INVENTION

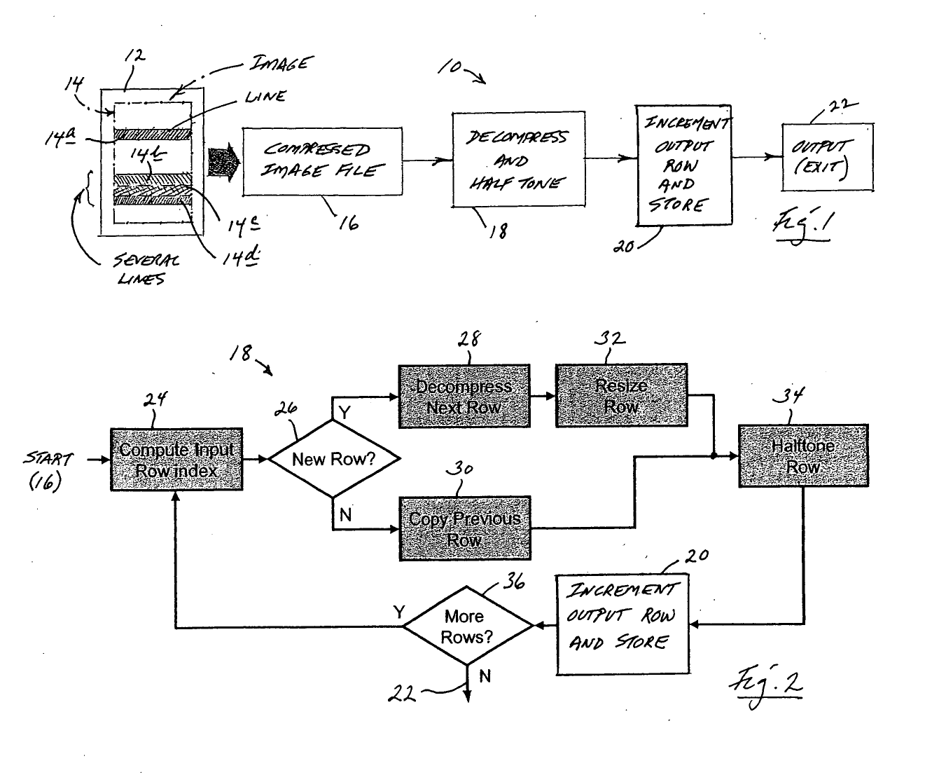

Turning now to the drawings, and referring first of all to FIG. 1, indicated generally at 10 herein are the structure and methodology, in their preferred and best-mode forms, of the present invention effectively engaged in an illustrative practice of the invention. At 12 in FIG. 1 is a document which is to be “handled”, including an image, shown in dash-dot lines at 14, which can be described as being made up of plural lines of pixels, such as the four lines shown at 14a, 14b, 14c, 14d. Line 14a is illustrated isolated from other lines in image 14. Lines 14b, 14c, 14d are illustrated as vertically next-adjacent lines in image 14.

By any suitable technique, and utilizing any appropriate compression algorithm, image 14 has been compressed into a compressed image file which is represented by block 16 in FIG. 1. Shown at 18 is a “Decompress and Halftone” block, a block 20 which is labeled “Increment Output Row and Store”, and an “Output”, or “Exit”, block 22. It is essentially within blocks 18, 20 that the structure, and the implementation, of, the present invention exist and take place, respectively. Block 20 is also referred to herein as storing structure.

As will be more fully elaborated, block 18 processes the compressed image file represented by block 16 by dealing with less that the entirety of the image file in different successive stages of processing. A preferred manner of practicing the invention involves addressing, within file 16, “staged” portions of that file that preferably take the form either of single lines (rows), or of several vertically contiguous lines (rows) of pixels.

With regard to a single line, or row, such as row 14, block 18 processes this, in accordance with the invention, as a row singularity. With regard to vertically contiguous rows, or lines, such as those indicated at 14b, 14c, 14d, block 18 effectively deals with these as a unit. Such a “unit” might typically take the form of vertically contiguous rows wherein vertically next-adjacent pixels are alike. Under no circumstance, however, does block 18 deal with the entirety of the image file, such as that represented by block 16.

Within block 18 decompression and half-toning, and if desired any resizing, etc., are performed, and in each stage of processing, or rather at the conclusion of each such stage, the decompressed, resized (if applicable), and half-toned partial result is stored in a buffer which can be viewed as being within block 20 in FIG. 1. When the entirety of image file 16 has been processed by staged decompression of portions of this image file, followed by staged half-toning of those decompressed portions, a final decompressed and half-toned output image is made available via block 22.

FIG. 2 in the drawings elaborates the process of the invention which has just been generally described with respect to FIG. 1. Thus, what can be seen in FIG. 2 is that included within block 18 in FIG. 1 are a “Compute Input Row Index” block 24, and a Yes/No “New Row?” inquiry block 26. Blocks 24, 26 are referred to herein collectively as selecting structure. The respective Yes and No output answers from block 26 are presented, respectively, either to a block 28 labeled “Decompress Next Row”, or to a block 30 labeled “Copy Previous Row”. Block 28 is also referred to herein as decompressing structure. An output from block 28 is fed to a block 32 which is labeled “Resize Row”, and which is also referred to herein as resizing structure, wherein any row (or line) resizing which may be required is appropriately performed. Associated with each of blocks 28, 32 is a conventional data-row buffer (not specifically shown) wherein a row of data processed by the particular block may be temporarily stored. Output from block 32 is supplied to a block 34 which is labeled “Halftone Row”. Block 34 is also referred to herein as half-toning structure. Output from block 34 is fed to previously mentioned block 20. With respect to information dealt with by block 20, there is provided another Yes/No inquiry block 36 which is labeled “More Rows?”.

In the practice of this invention, block 24 performs a computation indexing with respect to an input row, or plural input rows, that are to be processed. If, as determined by block 26, there is a new, single row (or plural rows) to process, decompression of that row, or rows, takes place in block 28 utilizing any appropriate decompression algorithm. The output from block 28 is then subjected to any called-for resizing, etc., in block 32, and the output from block 32 is then half-toned in block 34, with the resulting partial result then stored within the buffer mentioned earlier within block 20. If there are more rows to process, as determined by block 36, the process just described essentially repeats itself. Had the answer to the question posed by block 26 been No, then control would have been handed to block 30 whose functionality is clearly described by its labeling in FIG. 2. More specifically, block 30 looks to the data row which is then temporarily stored in the data-row buffer associated with block 32, and sends this row to block 34 for half-toning.

The architecture of an algorithm which may successfully be employed in this just-described process is as follows:

while (Number of Scan lines >= 0)

if (Source Line == Previous Source Line)

Re-halftone previous line;

else

read jpeg scan lines;
Resize Line;
Convert to Printer K;
Halftone Line;
Previous Source Line = Source Line;

```
  end if
  Target Index += Target Stride;
Source Line += └Source Height / Target Height┘
  E += modulo[Source Height / Target Height];
  if (E >= Target Height)
```

E −= Target Height;
Source Line += Source Stride;

end if

end while

In this manner, an entire image, such as image 14, is processed on the basis of less than whole-file units selected from the related compressed image file. Processing takes place in stages, with such selected data units being first decompressed, resized if necessary, and then half-toned and stored in a buffer, until the entire image has been dealt with. The process thus followed by practice of the invention is both speedy and efficient.

Accordingly, while a preferred embodiment and certain manners of practicing the invention have been described herein, it is appreciated that other variations and modifications may be made without departing from the spirit of the invention.

1. A processing method for the staged decompressing and half-toning of a compressed digital image file which is defined by plural data rows comprising
selecting from the image data file a yet un-compressed row region which makes up less than the whole image file,
decompressing the selected row region,
half-toning the decompressed row region,
storing the half-toned row region, and
repeating, seriatim, the selecting, decompressing, half-toning and storing steps until the whole image file has been so processed.

2. The method of claim 1 which further comprises, where a selected row region is the same as the last previously processed row region, skipping the decompressing step, and re-half-toning and storing the decompressed version of the last-processed row region.

3. The method of claim 1 which further includes, intermediate the decompressing and half-toning steps, the optional step of resizing a just-decompressed row region.

4. The process of claim 3 which further comprises, where a selected row region is the same as the last previously decompressed and optionally resized row region, skipping the decompressing and optional resizing steps, and re-half-toning and storing the decompressed and optionally resized version of the last-produced row region.

5. The process of claim 1, wherein the selected row region includes but a single data row.

6. The process of claim 1, wherein the selected row region includes plural data rows.

7. Apparatus for performing staged decompressing and half-toning of a compressed digital image file which is defined by plural data rows comprising
selecting structure for selecting from the image data file a yet un-decompressed row region which makes up less than the whole image file,
decompressing structure operatively connected to said selecting structure for decompressing a selected row region,
half-toning structure operatively connected to said decompression structure for half-toning the decompressed row region,
storing structure operatively connected to said half-toning structure for storing the half-toned row region, and
repeat structure operatively connected to said storing structure for effecting a seriatim repeat of the respective operations of said selecting structure, said decompressing structure, said half toning structure and said storing structure until the whole image file has been processed.

8. The apparatus of claim 7 which further comprises an optionally employed resizing structure which is operatively interposed said decompressing structure and said half-toning structure, with said resizing structure being operable optionally to resize a just-decompressed row region.
